(19) United States
(12) Patent Application Publication
(10) Pub. No.: US 2002/0049708 A1
(43) Pub. Date: Apr. 25, 2002

(54) Diverse data compilation, management and manipulation in a static interface environment

(76) Inventors: Vincent B. Moneymaker, Manhattan Beach, CA (US); Anthony Gaw, Henderson, NV (US)

Correspondence Address: VINCENT B. MONEYMAKER, 700 SOUTH FLOWER STREET, SUITE 2102, LOS ANGELES, CA, 90017, US

(21) Appl. No.: 09/846,787

(22) Filed: May 1, 2001

Related U.S. Application Data
(60) Provisional application No. 60/201,541, filed on May 2, 2000.

(51) Int. Cl. G06F 7/00

(52) U.S. Cl. 707/1

(57) ABSTRACT

The present invention provides a method and system for selecting and/or ordering information and/or items in a networked computer environment. The method and system enables multiple items of information and/or products to be presented, manipulated, configured and selected by a client/user via a single emanation of a graphical interface environment (i.e. a single computer screen ‘web page’) without the client/user ever having to leave this static environment in order to complete the process of selecting the items of information or products he or she desires. The present invention enables entire product lines, such as, for example, a restaurant's entire menu, to be made available for networked use by a client/user via a single ‘web page’ so that each item on the menu can be displayed and selected by the client/user. And no matter the complexity of the choices presented, even if secondary, tertiary, or quartic subsets of choices are presented, these choices can be displayed, manipulated, configured and selected all through the same static interface environment. In effect, the present invention allows a business to display all of its products for sale via a single web page and then have its customers order any of these products, or their relevant subsets of options, without the customer ever having to leave this single web page.

### CROSS-REFERENCES TO RELATED APPLICATIONS

This application is entitled to the benefit of Provisional Patent Application Ser. #60/201541, filed May 2, 2000.

### STATEMENT REGARDING FEDERALLY SPONSORED RESEARCH OR DEVELOPMENT

Not applicable.

### BACKGROUND OF THE INVENTION

The present invention relates to information disclosure and/or product selection systems which occur via computer networks, such as local area networks, wireless networks, intranets and the Internet. Such systems are typically effectuated through programs commonly known as shopping cart programs. In a typical example, these programs enable a user to select an item or product through a graphical interface such as a computer screen ‘window’ or ‘web page’ and then have the item or product added to the user's computer generated ‘shopping cart.’ Once the user has selected all of the items or products he or she desires, the items in the shopping cart are summed so that the user can see the total price for the items selected and the user can then either complete the transaction or the user can stop the process by abandoning his or her order.

The principal problems with such shopping cart programs are that they have required a user to proceed through multiple windows or web pages to select desired items, as well as to complete the ordering of these items. As a result of these processes, most online ordering web sites (such as, for instance, ‘food.com’ or ‘waitersonwheels.com’) have clunky shopping carts which produce frustrating experiences for client/users who have to proceed through multiple pages in order to complete an order for the items the client/user desires to purchase. And this does not even take into account the extremely frustrating aftermath that occurs if a client/user has to change his or her order, which leads to the client/user having to proceed through yet another series of web pages in order to complete the order editing process. Further, current programs severely restrict a company's ability to display a complete menu of the items it sells because each possible combination of subitems which are associated with a particular item (such as the pizza toppings that come with a pizza) either have to be displayed on the main menu page (which produces extremely long and hard to read menus) or separate pages have to be created which display the subitems that are associated with a particular item that a client/user has decided to order.

As a result of these problems, it is often times quite difficult and expensive for businesses to sell their wares via computer networks such as the Internet because web designers have to be employed to create multiple pages of menu information so that all of the choices that would be available to a client/user over the phone are also available to the client/user via the Internet (albeit in a significantly less user friendly environment than would occur if the user simply phoned the business to make and complete his or her order). Utilizing multiple pages to display menu information, in turn, leads to an almost claustrophobic like effect whereby a client/user is never really able to see concurrently all of the products a particular company sells, in contrast to what would happen if the client/user were to simply have a company's list of products or menu of items faxed to him or her. Even more problematic for businesses which desire to sell their wares via computer networks is the fact that, utilizing current shopping cart programs, item choices involving rather routine complexity in the real world (such as ordering a dinner which comes with a choice of appetizers (which appetizers, in turn, come with a choice of toppings) along with a choice of side dishes and choice of the manner in which the dinner is to be cooked), cannot be simply and effectively rendered via a web page so that the ordering process is equivalent in ease of use to that which would occur over the phone. In such cases, the subsets of choices available to the user have to be broken up into separate pages so that all of the possible combinations available to the client/user can be effectively displayed. Either that, or the choices available to the client/user have to be restricted so that no secondary or tertiary or quartic choices are available.

Quite understandably, this lack of flexibility in ordering programs has had a deleterious effect on online ordering transactions such that often times people simply give up on ordering something over a computer network, such as the Internet, because the ordering process is both too restrictive and too inflexible, which at times seem to be the hallmarks of the Internet culture.

### SUMMARY OF INVENTION

In order to solve the aforementioned problems, a system is needed which enables choices, be they large in number and/or complex in result, to be presented to a client/user in a simplified environment which enables the client/user to easily navigate the choices available to him or her and to then easily decide on the exact combination he or she desires, so that customer satisfaction is maintained, customer frustration eliminated and producer expenses and technical difficulties eased.

An object of the present invention is to satisfy such a need by providing a static interface environment which allows items and/or information to be presented to a client/user via a single emanation of a graphical interface environment, such as a ‘window’ or ‘web page.’ Utilizing the present invention in this manner, multiple sets of information and/or items or products can be displayed graphically via a single page which a client/user can then review. The client/user can then select and/or order any of the items and/or information being offered for sale or selection without having to leave this static environment in order to complete the selection and/or ordering process. An object and advantage of this system is that a business's entire line of products can be presented in a simple and straightforward manner on a single web page so that the review and selection of the products offered is made easy for a client/user. Another object and advantage of this system is that a client/user can change his or her order in almost any fashion he or she wants without having to move from page to page in order to complete this editing process. Another advantage of this system is that it reduces technical and expense limitations for businesses which desire to offer their services and/or products for sale via computer networks. The present invention accomplishes this by eliminating needless web pages and, hence, needless web design costs and implementation issues. Yet another object and advantage of this system is that choices are enhanced for client/users because the system enables complex choices, involving secondary, tertiary and quartic subset levels of information and/or items, to be presented to the client/user in the same static interface environment such that the client/user can select exactly the desired options or subsets of items that he or she desires. As a result, combinations of choices on the order of 20,000,000 distinct combinations of choices can be presented to a client/user without the client/user ever having to leave the single web page he or she is viewing the items from. Further objects and advantages of this system include the ability to increase transactional throughput, the decrease of client/user frustration associated with having to proceed through multiple web pages to complete desired selections of items and the ability to present complex choices in a simple and straightforward environment which enables the client/user to pick and choose exactly what he or she wants in the exact manner and quantity desired. Still further objects and advantages of the present invention will become apparent from a consideration of the ensuing description and drawings.

### BRIEF DESCRIPTION OF THE DRAWINGS

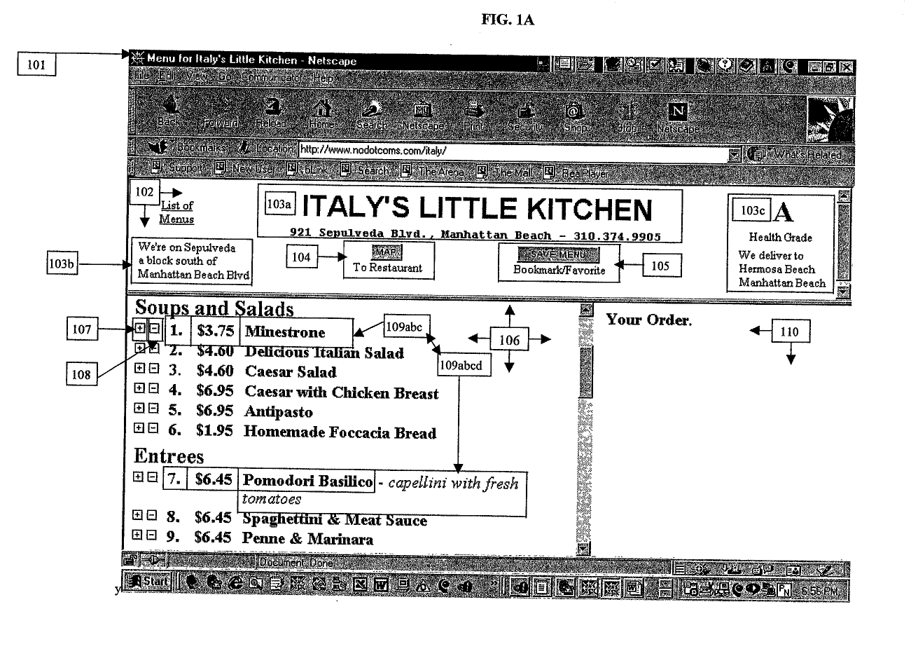

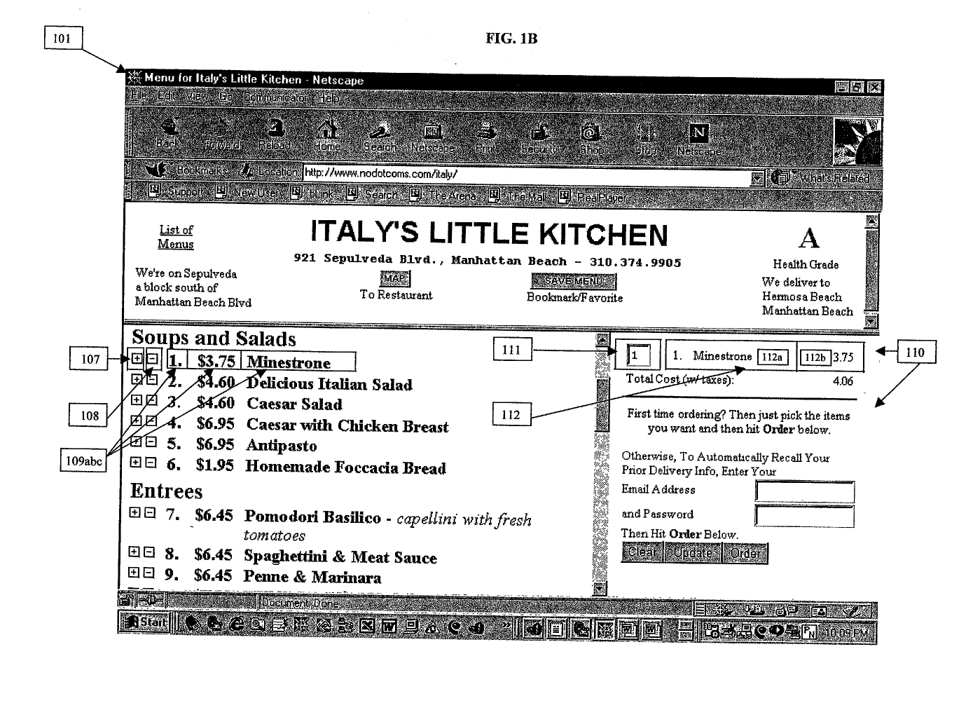

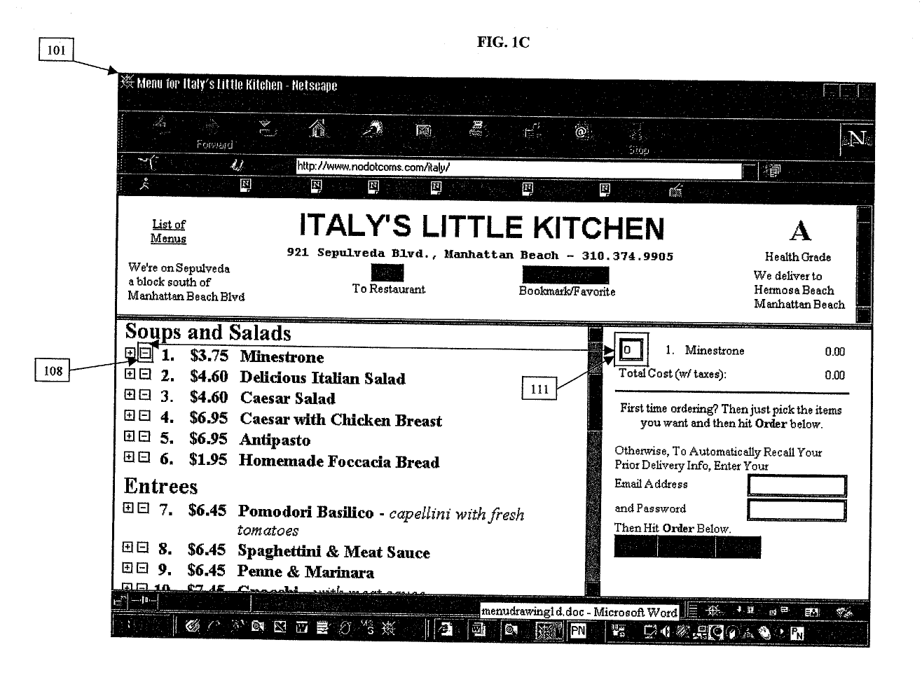

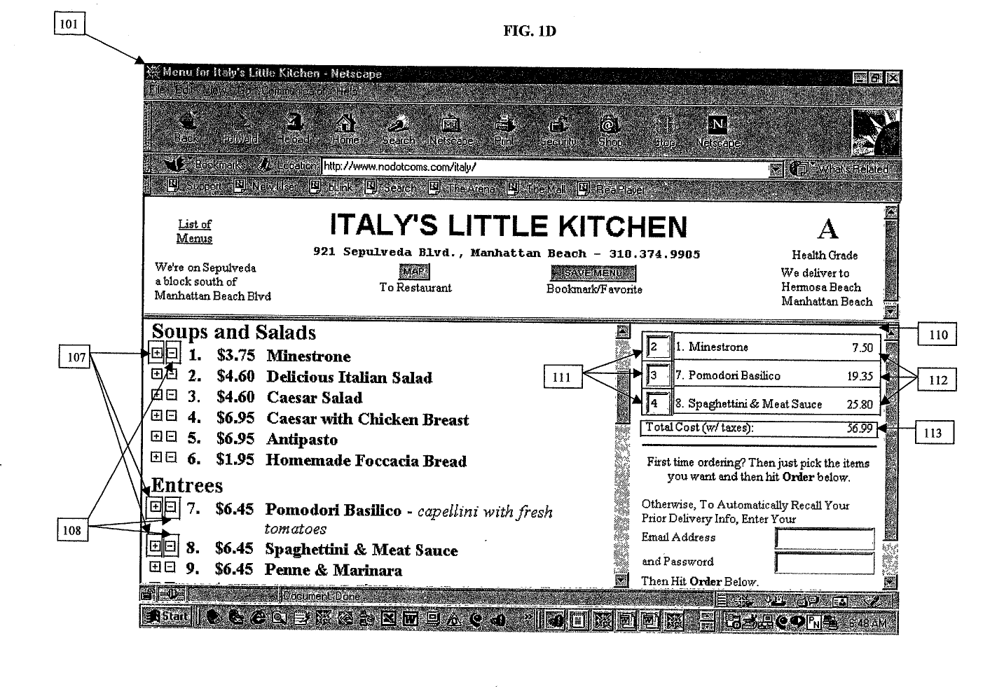

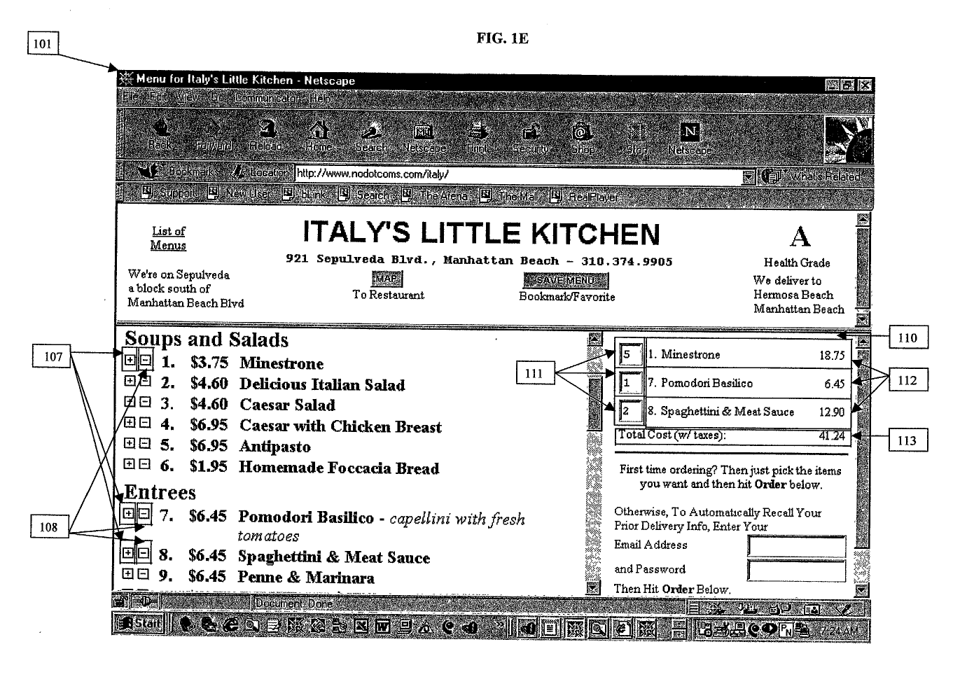

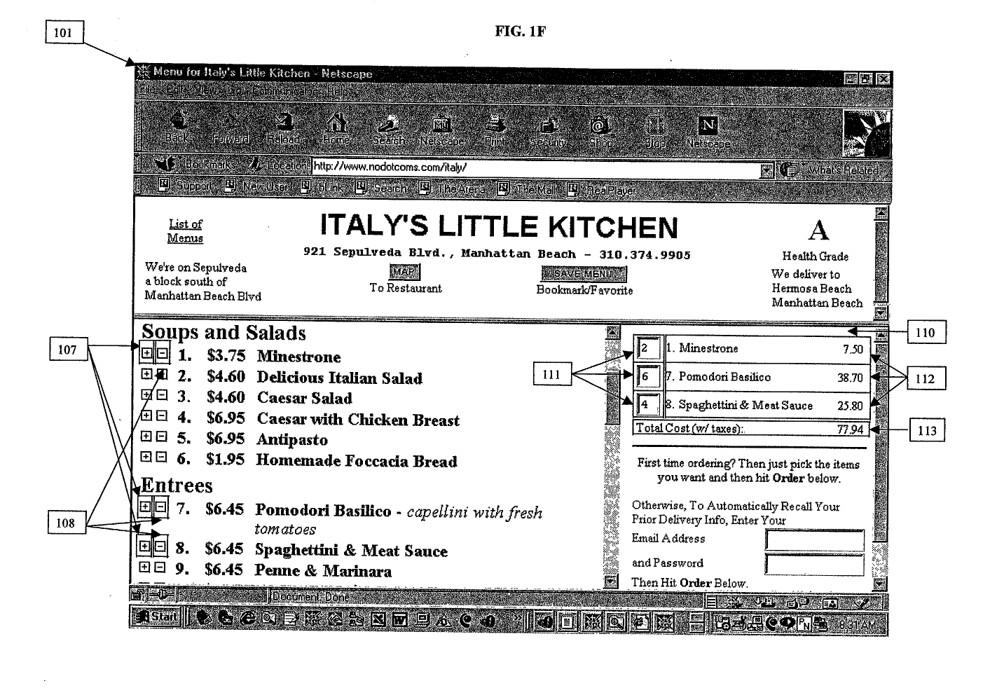

1. FIGS. 1A-F illustrate one embodiment of the present invention in graphical interface form as it appears seen via a client/user's browser, whereby items, data or information can be chosen, on the client/user side of a client/server environment for calculation, manipulation or transactional ordering without manual entry of the items, data or information being required.

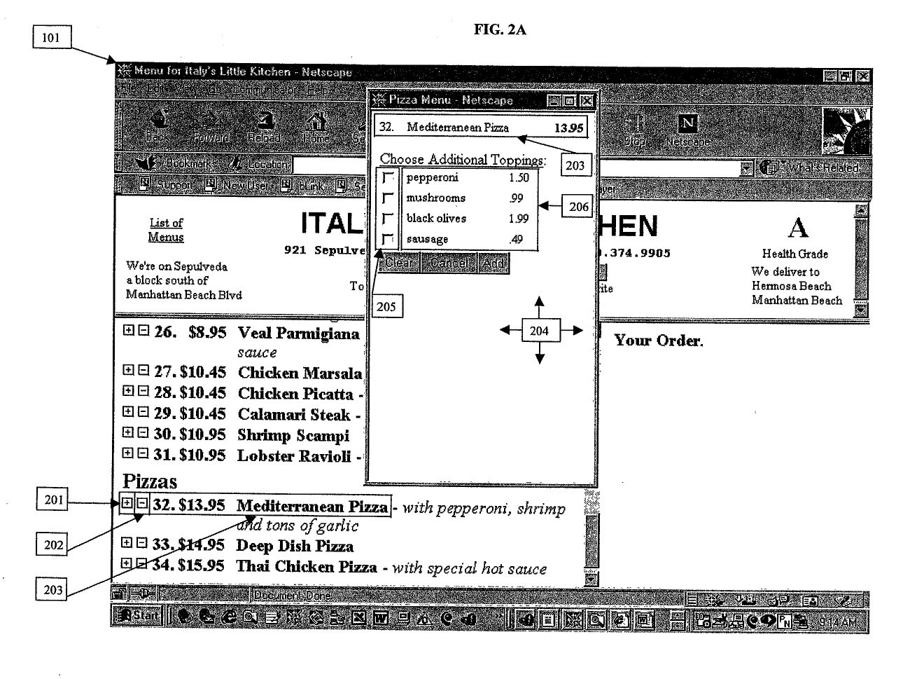

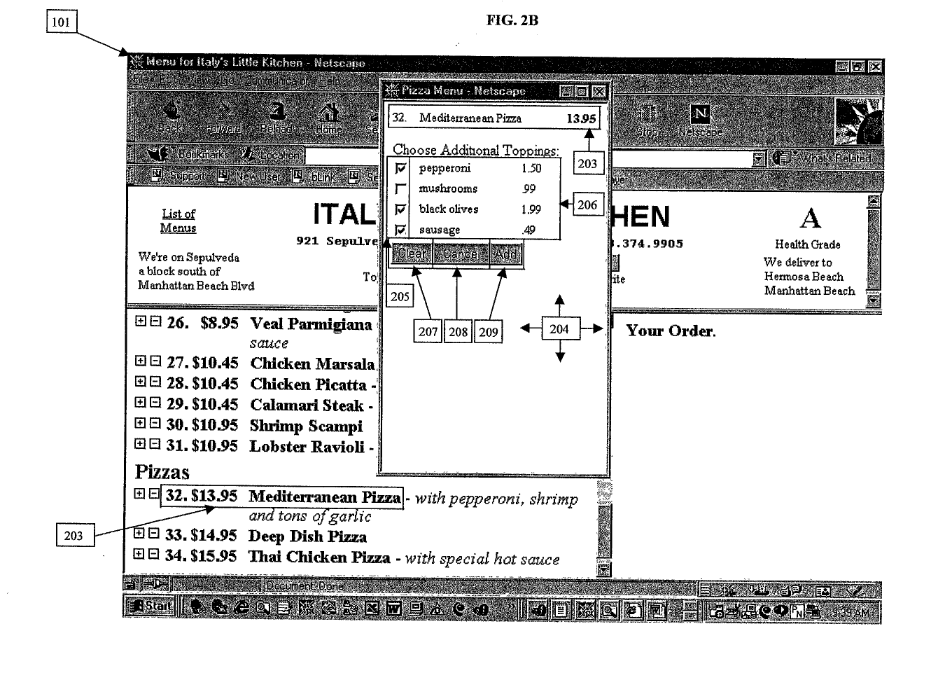

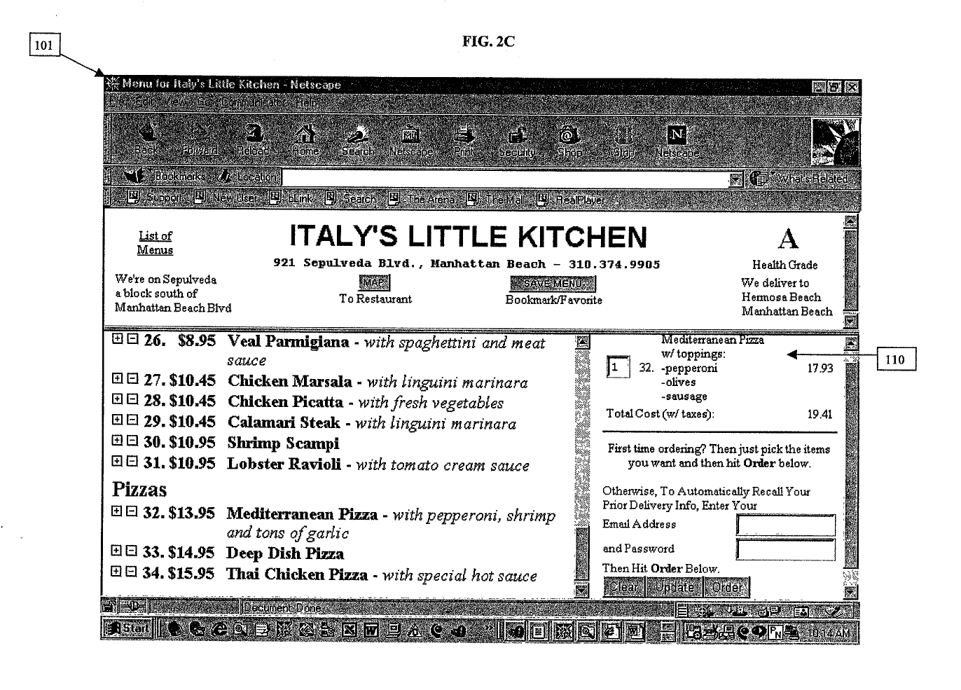

2. FIGS. 2A-C illustrate an embodiment of the present invention whereby multiple combinations of items, data or information can be selected on the client/user side of a client/server environment and then manipulated within the confines of a client/user's static interface environment.

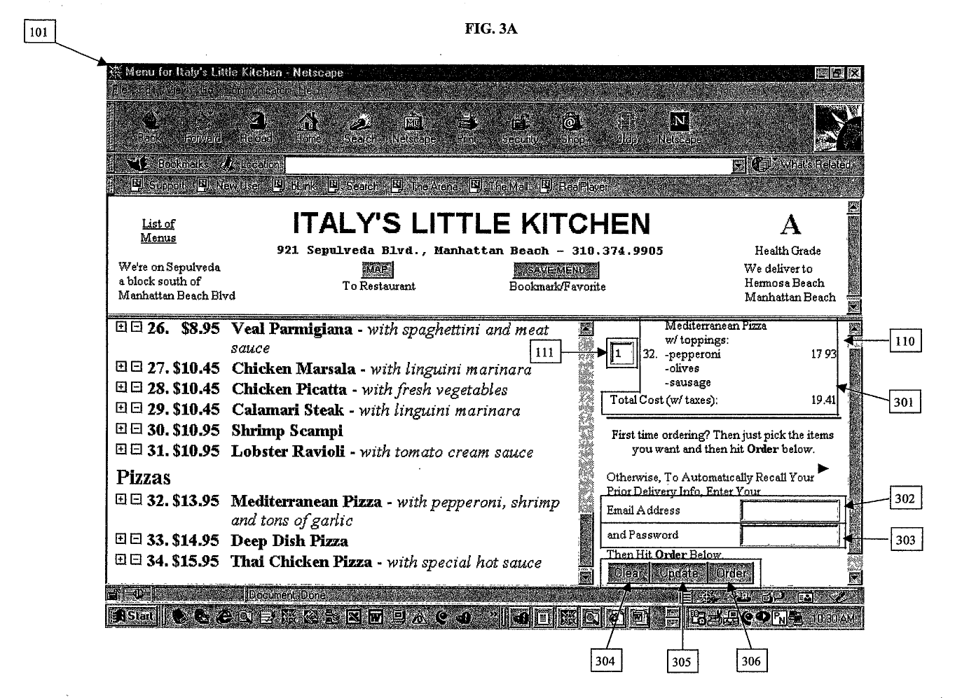

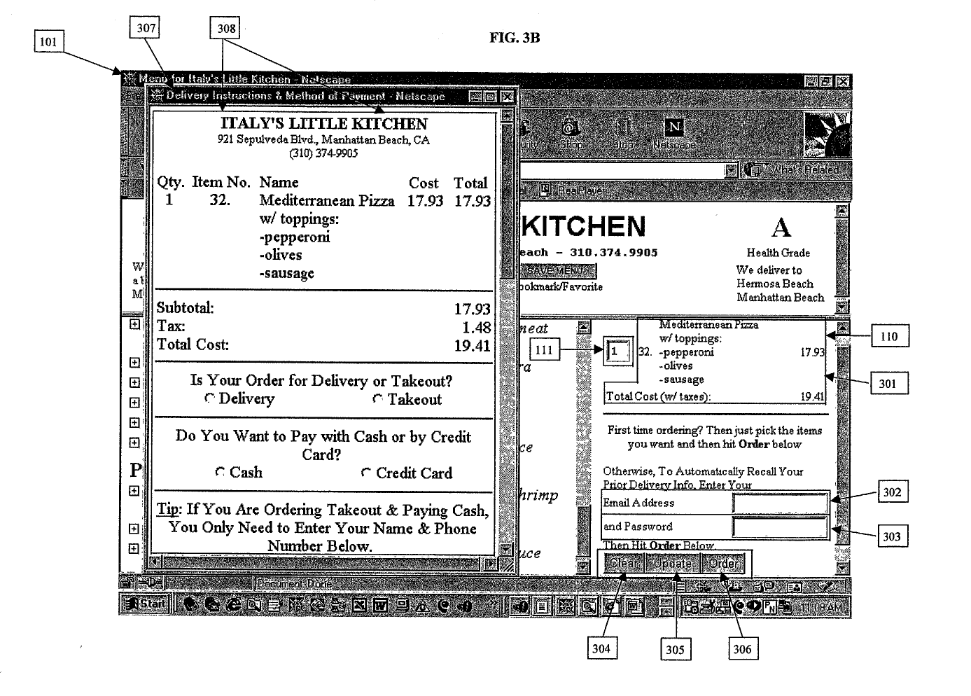

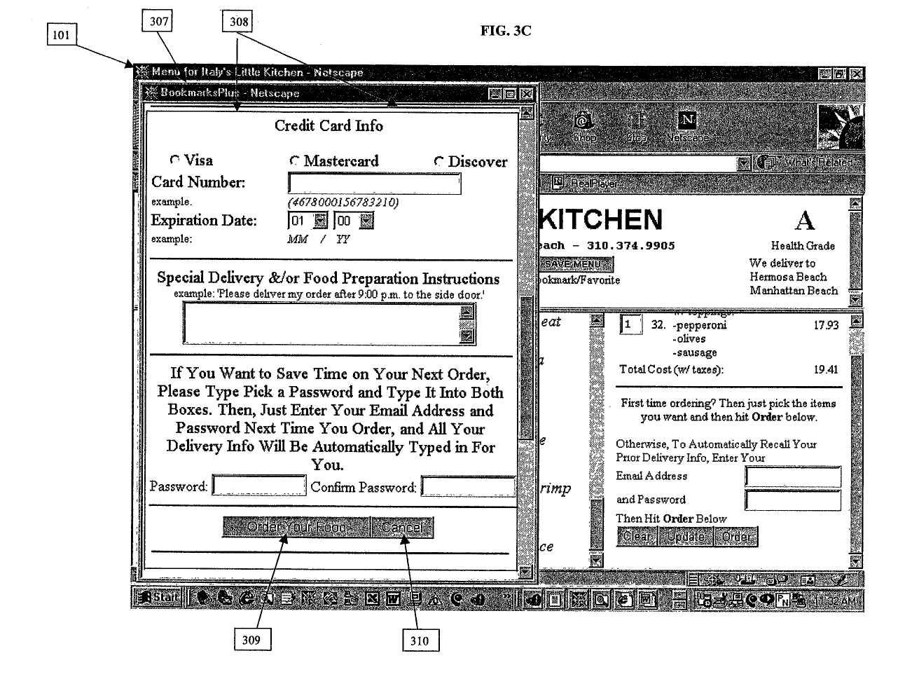

3. FIGS. 3A-C illustrate an embodiment of the present invention whereby items, data, or information are transmitted, on the client/user side of a client/server environment, from a client/user's static interface environment to a server via a computer network, such as the Internet, for storage, manipulation and/or the completion of transactional orders.

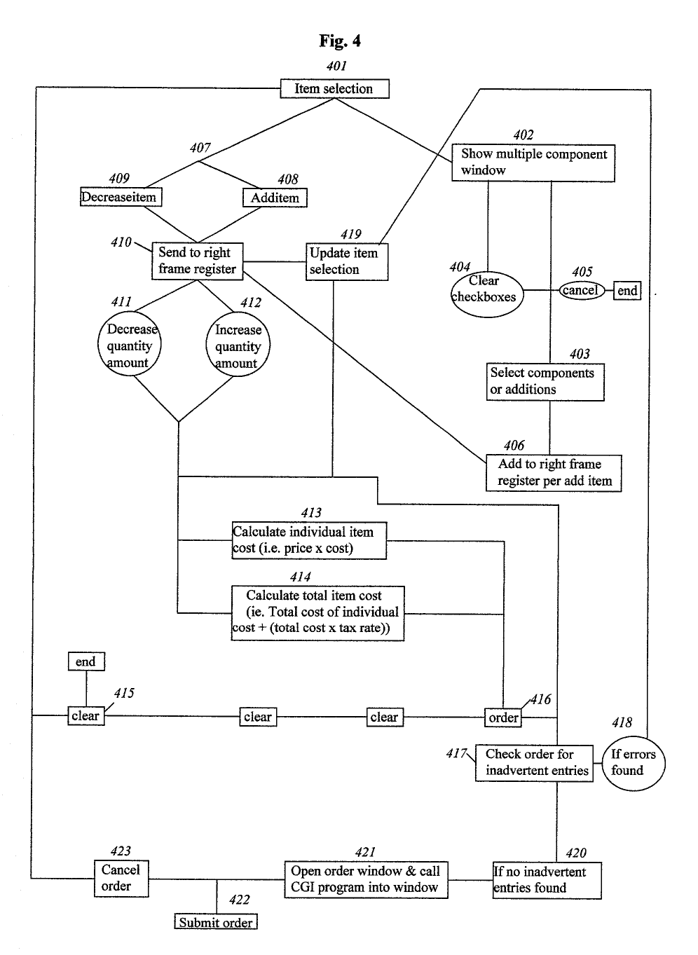

4. FIG. 4 is a flow chart of a routine for enabling and then processing a client/user's selection of items, data or information for storage, manipulation or transactional ordering within the confines of a client/user's static interface environment.

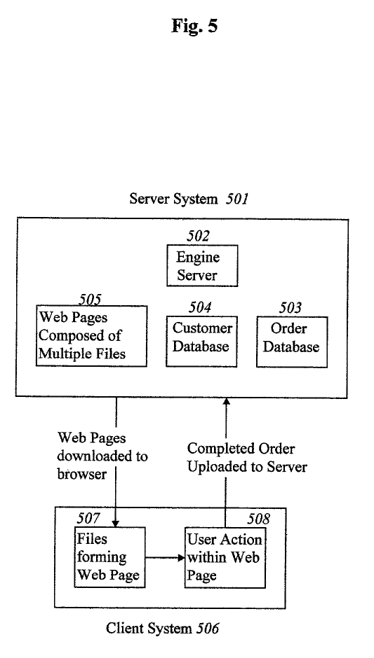

5. FIG. 5 is a block diagram illustrating an embodiment of the present invention.

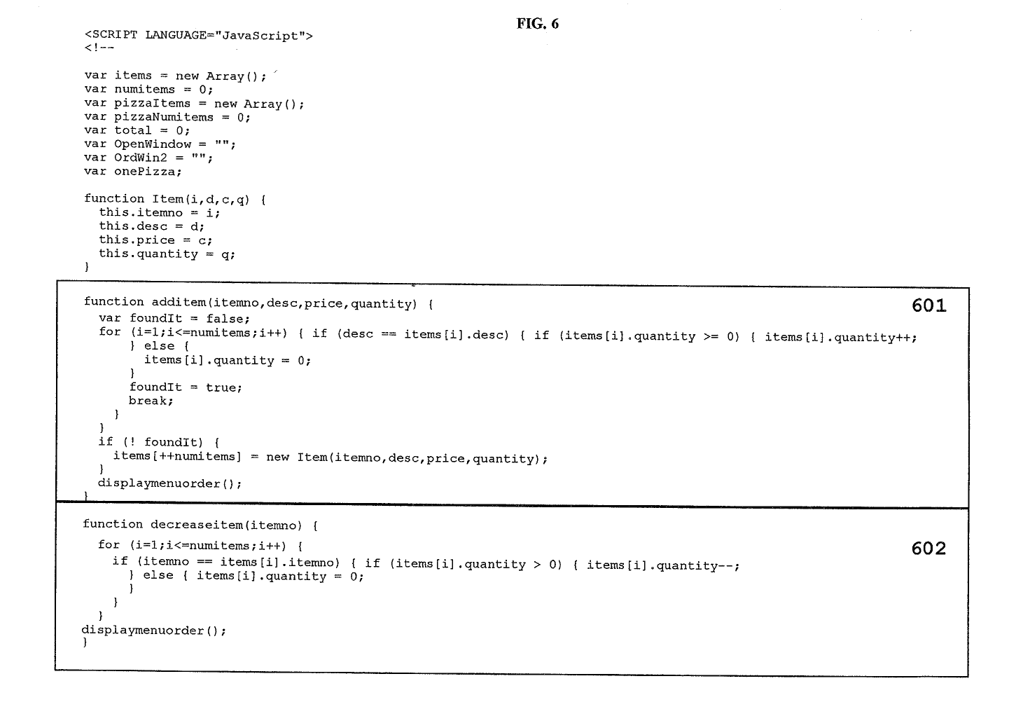

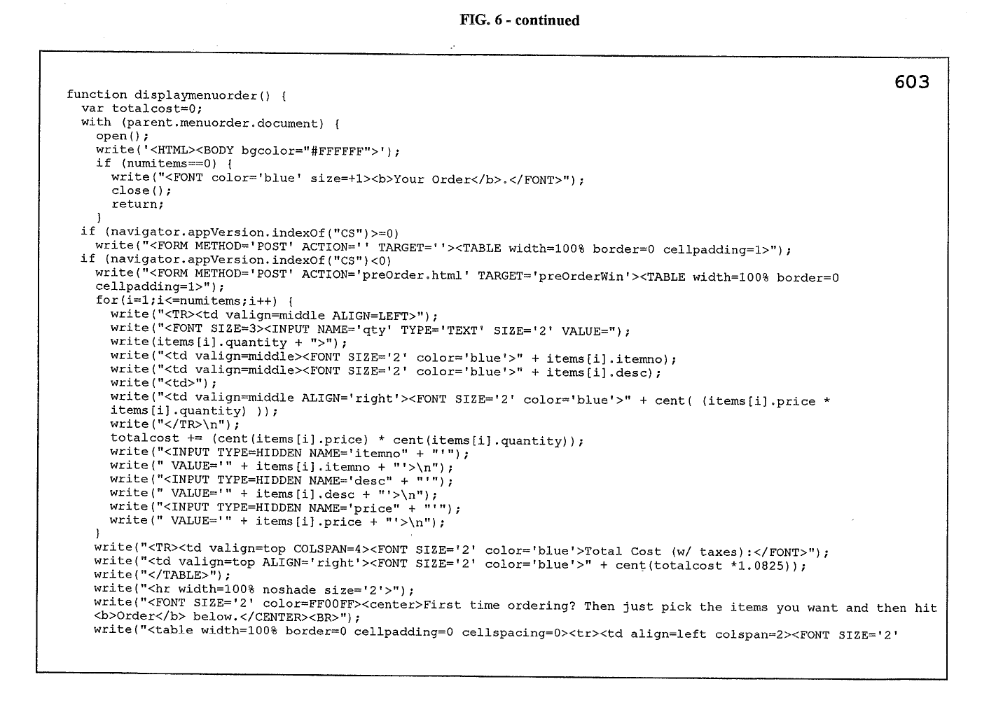

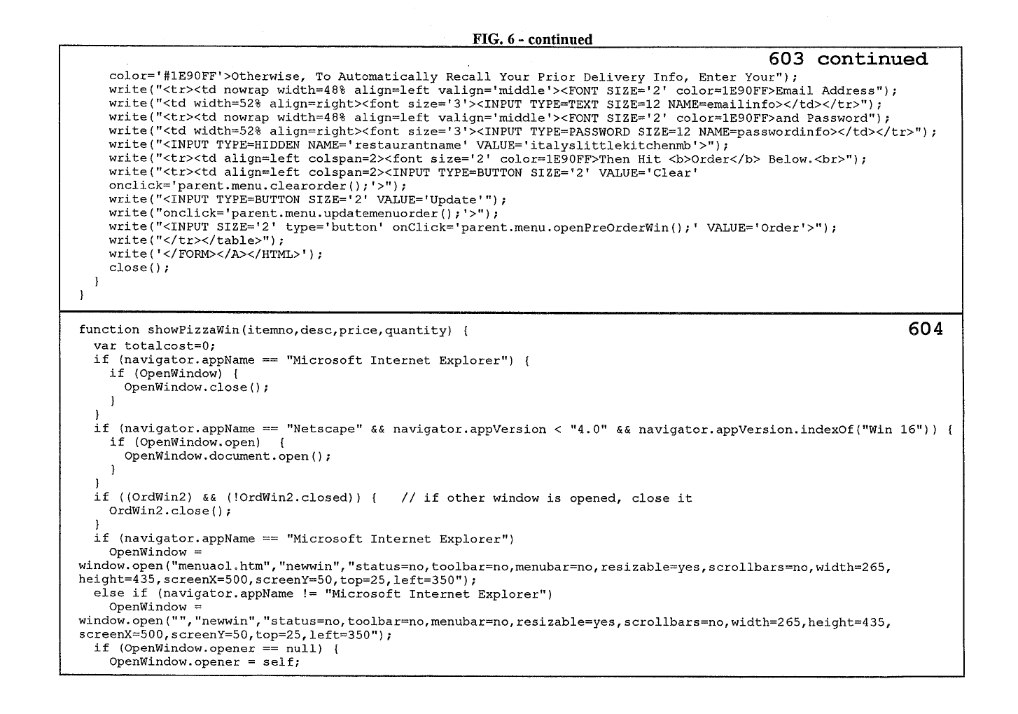

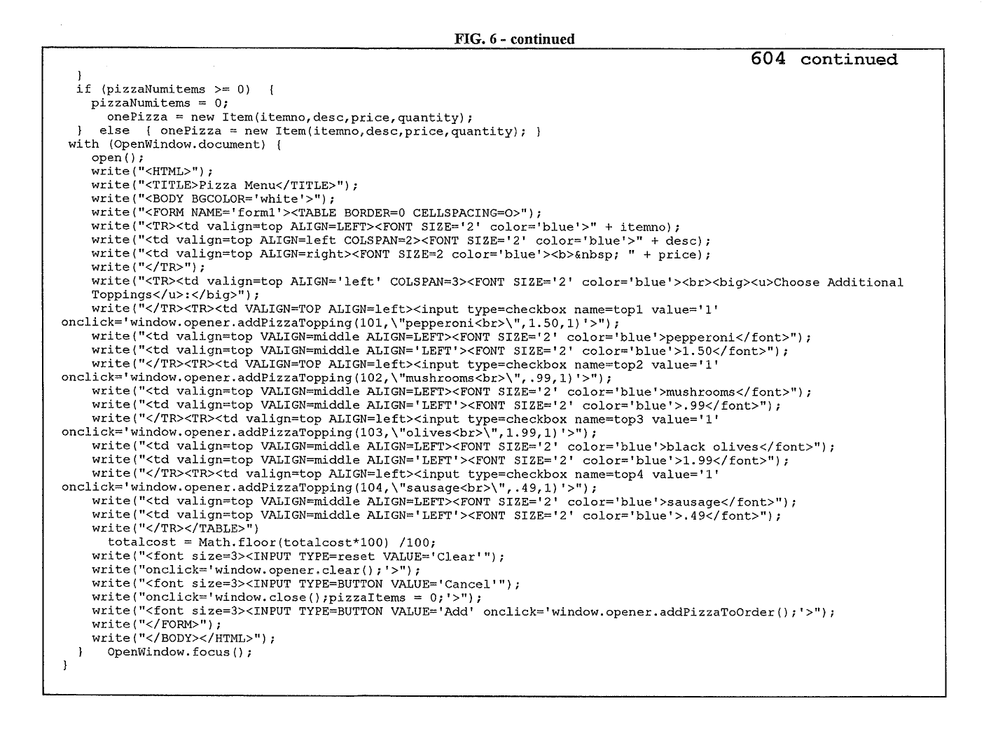

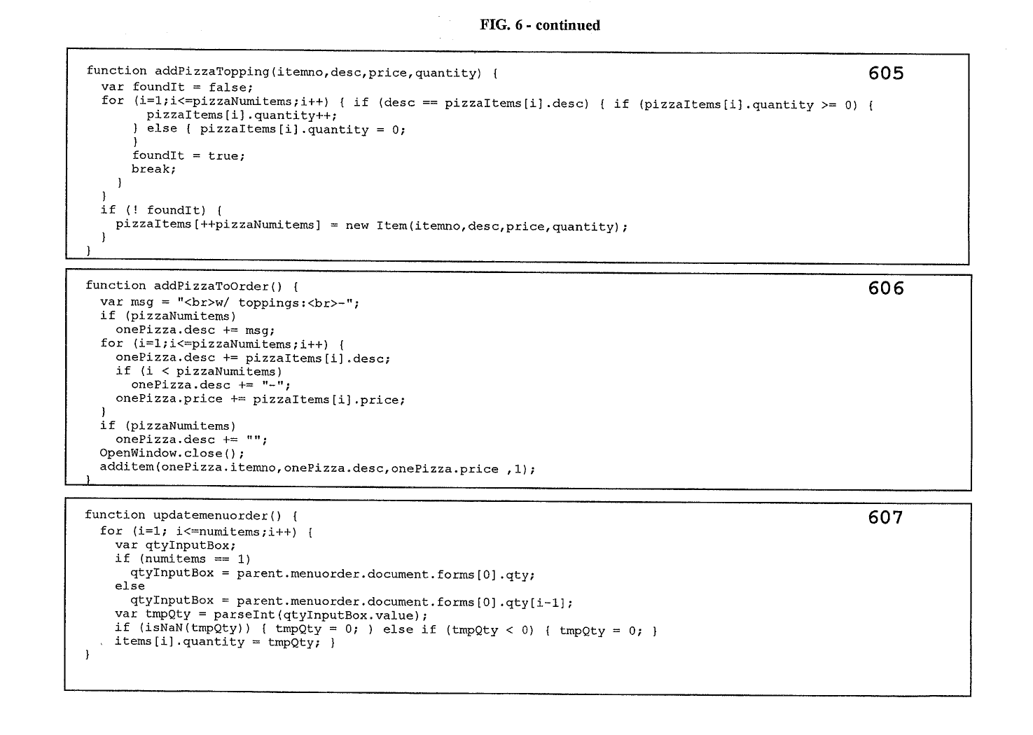

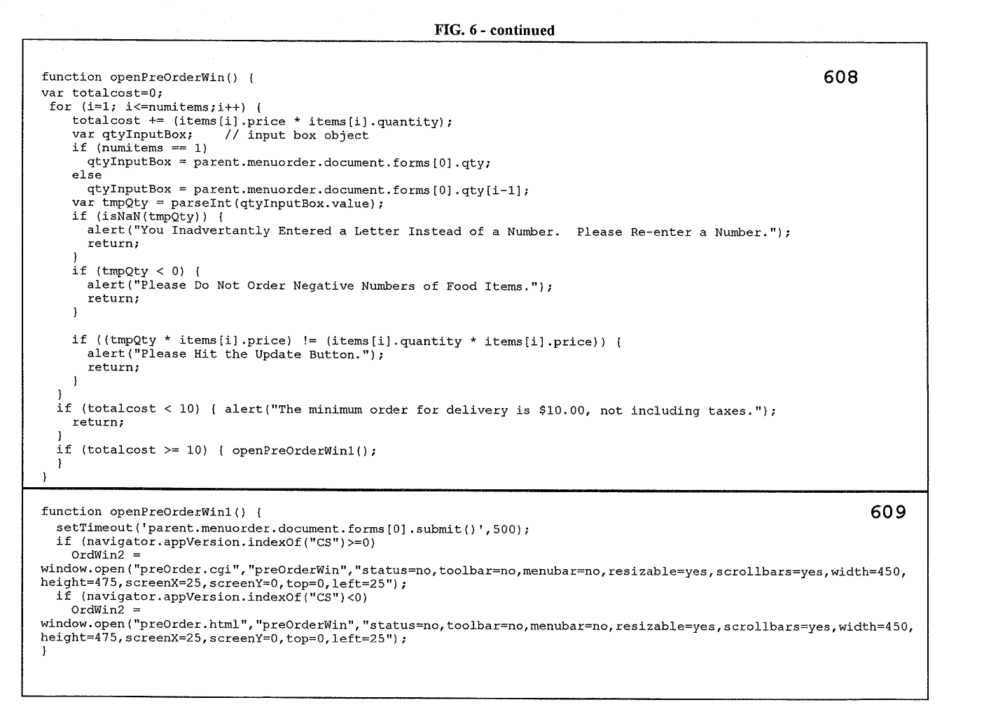

6. FIG. 6 illustrates an embodiment of the present invention written in the programming language Javascript.

### DETAILED DESCRIPTION OF THE INVENTION

The present invention provides a method and system for client/users operating in a client/server computer environment to select, calculate, and/or manipulate (the terms ‘select’, ‘calculate’ and ‘manipulate’ are collectively referred to hereafter as “select”, “selected” or “selecting”) multiple items, data, and/or information (the terms ‘items’, ‘data’, and ‘information’ are collectively referred to hereafter as “item” or “items”) within a static interface environment and then transmit the selected item or items to a server via the same static interface environment. Thus, the present invention essentially creates a one page shopping environment whereby a client/user can select items, alter their composition into myriad forms, perform calculations on them, such as increasing or decreasing their quantity, or otherwise manipulate them via a static interface environment (e.g. via a single Web page), without having to manually type in any information relating to the items or their composition. The items selected by a client/user can then be sent to a server, via a computer network, for storage, manipulation and/or completion of transactional orders (the terms ‘storage’, ‘manipulation’ and ‘completion of transactional orders’ are collectively referred to hereafter as “order” or “orders” or “ordering”), and without the client/user having to leave the static interface environment (the term static interface environment is referred to hereafter as a “Web page”), through which the selection process has taken place. Thus, this invented system and method allows a client/user to obtain, alter, select and then order a myriad of items in a myriad of forms without having to shift from one Web page to another in order to complete the ordering process. This method and system thus saves time, expense and operational wear and tear for both client/users and servers while at the same time greatly expanding the choices available to client/users when orders are conducted and completed via a computer network.

In one embodiment of the present invention, a client/user calls a computer program from a server, via a computer network such as the Internet, by inputting a unique universal resource locator identifier (e.g. “www.example.com”) into a location bar, or other such search mechanism, on the client/user's computer browser (e.g. Internet Explorer 5.0 or Netscape Navigator 6.0). A computer browser (referred to hereafter as “browser”) is a computer program which allows a client/user to search for and display for the client/user, on his or her computer screen, viewable interfaces such as Web pages, which may include additional programming and information manipulation capabilities. Browsers are referred to in the present embodiment of the invention because they are the type of application most commonly used to search for information and/or web pages over the Internet. However, any application which is capable of searching for information and obtaining information over a computer network, such as the Internet, could be utilized with the present invention. Thus, the present invention is not restricted to being used with or by browsers.

Inputting the universal resource locator identifier (referred to hereafter as “URL”) into a browser's search mechanism allows the client/user's Internet browser to identify and then request for downloading a specific Web page which the client/user desires to view on his or her computer screen, via his or her browser. The request for the desired Web page is then sent over the Internet utilizing a computer language protocol such as HyperText Transfer Protocol (referred to hereafter as “HTTP”). The request for the desired Web page is then routed based on its URL identifier to a server supporting the particular Web page, which the client/user desires to view. The server receiving the routed request for the Web page then responds by transmitting the requested Web page, via HTTP, back to the client/user who has requested the Web page. The Web page received by the client/user may then be defined for viewing and used on a client/user's computer screen, through a browser, by means of a computer language such as HyperText Markup Language (“referred to hereafter as “HTML”), which embeds certain defined commands, or tags, in the file or files comprising the Web page. These tags then control how text, graphics, controls and other features associated with the Web page are displayed and used by the client/user via his or her computer screen.

The Web page received by the client/user may be received into the random access memory (hereafter referred to as “RAM”) of the client/user's computer in the form of multiple computer files, which may includes files written in HTML, as well as graphics files, which operate together to form a single Web page. Though viewable as a single Web page, the Web page may itself be partitioned into separate parts, or frames, which may allow a myriad of items to be displayed, altered, and then selected for ordering, all within the confines of a single Web page, which the client/user is not required to leave in order to complete the ordering process.

A frame on the left side of the client/user's computer screen (hereafter referred to as the “left frame”) may contain a list of items, which the client/user can add to or subtract from a register of items which is kept in a frame on the right side of the computer screen (hereafter referred to as the “right frame”). These items may be selected from the left frame and then added to or subtracted from the register through the use of a device such as a mouse, or even a voice command, without the client/user having to manually type in any information relating to the items selected by the client/user.

Items which are selected in the left frame of the Web page may also be configured to invoke small overlay windows which allow the client/user to continue viewing the Web page, and the list of items contained thereon, while at the same time enabling the client/user to view separate lists of components parts of, or additions to, a selected item. Based on the needs of the client/user, the component parts or additions can then be added to or subtracted from a selected item, thus forming a uniquely configured item, which suits the individual needs of the client/user. This uniquely configured item can then be added, in the exact form desired by the client/user, to the register contained in the right frame of the Web page.

Utilizing an overlay window which is only 6″ tall and 3½″ wide, and which is thus situated over only a small portion of the Web page, a client/user can achieve a configuration combination rate of over 20,000,000 separate combinations for each particular item. Such configuration combination rates, moreover, are possible utilizing files which can be rapidly downloaded given that, together, they typically total no more than 50 kilobytes in size. These files, which generate the Web page seen by the client/user, can just as easily be deleted from a client/user's computer given their minimal combined size and the fact that they reside in such rapidly accessed storage areas as the RAM on a client/user's computer.

As each item is selected, configured in the manner desired by the client/user, and then added to or subtracted from the right frame of the Web page, a register is maintained in the right frame which automatically shows desired parameters relating to the items selected, such as their type, quantity, price, and total amount. These parameters are then automatically updated as items in the left frame are added to or subtracted from the register maintained in the right frame. Additionally, items maintained in the right frame are subject to further manipulation by means of controls which may be maintained anywhere on the Web page, including in the right frame, which allow functions such as clearing items, or manually updating their particular parameters, to take place

Upon selecting items in the form desired, and having arranged their relevant parameters in the preferred manner, the client/user can either proceed immediately with completing his or her order, or the client/user can first input preselected identifiers, such as a password and email address, and then proceed with completing the client/user's order. If the client/user inputs his or her preselected identifier (hereafter referred to as a “password”) and then proceeds with completing the order, the order item or items chosen by the client/user, along with the client/user's identifier information, may be transmitted to a server, such as the server which originally downloaded the Web page at the request of the client/user. Using the identifier information transmitted to it, the server is then enabled to conduct a search of a database maintained either onsite, or offsite at a third party server, for the order enabling information which relates to the client/user identifier information inputted by the client/user. One skilled in the art will recognize this as a conventional password system, which allows order enabling information unique to the client/user to be saved for subsequent inputting into ordering forms which the client/user has invoked, thereby saving time and effort for the client/user who does not want to have to continually retype in order enabling information.

Once the client/user is identified and the client/user's unique order enabling information is recalled, which may include such information as the client/user's name, address, phone number, credit card number, credit card expiration date, and/or other identifier information, the order enabling information may then be automatically inputted into a form, such as an HTML defined ordering form. Such a form may be generated by means of a common gateway interface (referred to hereafter as “CGI”) program written in a computer language, such as C, C++ or Perl. Alternatively, a client/user who does not have a password or who does not want to take the time to obtain one, may choose to invoke an HTML defined ordering form directly without the form containing any order enabling information.

Either way, the step of completing the ordering process may next be taken by invoking a posting method whereby a CGI generated ordering form is called for and the client/user's order information is then transmitted to the ordering form. The ordering form in the present embodiment, which is generated and maintained on the server side of the client/server environment, may be targeted through a window which is defined on the client/user side. Such a window may be a relatively small overlay window which allows the client/user to continue viewing the Web page, and the items or information contained thereon, while at the same time enabling the client/user to complete the ordering form so as to finalize the ordering process. The ordering form may then either be submitted to conclude the process or the ordering form may be canceled, which results in the overlay window being eliminated while at the same time allowing the client/user to continue selecting items. These newly selected items can then be submitted immediately for ordering once again. Thus, the entire one page ordering process provides a client/user with maximum ordering flexibility in the form of myriad items, or combinations thereof, which can be chosen from, without requiring the client/user to waste time shifting from one page to another in order to complete the ordering process.

FIG. 1A illustrates one page shopping in one embodiment of the present invention. The illustration presented is of a web page 101 downloaded from a server to a client/user's computer and seen via the client/user's browser. This example web page 101 is composed of three frames. Specifically, there is a top frame 102, a left frame 106 and a right frame 110. Within top frame 102, there is a business identifier 103a of a business which web page 101 may be developed for, and a subsection business identifier 103b and another subsection business identifier 103c, which contain relevant information relating to the business. In addition, top frame 102 contains a map button 104 which may be invoked by a mouse or other device in order to obtain a downloaded web page which web page would then display a map showing how to get to the business that web page 101 has been developed for. A save page button 105 is also contained in top frame 102. This save page button 105 allows the URL for web page 101 to be saved as a bookmark in Netscape Navigator based browsers, or, alternatively, saved as a favorite web page in Internet Explorer based browsers. By simply clicking save page button 105, a client/user can save web page 101 in the bookmark/favorites section of the client/user's browser in order to obtain, at a later time, an immediate download of the component files making up web page 101. One skilled in the art will recognize the form of top frame 102, along with the text and controls and other features contained therein, to be subject to rearrangement in a number of ways. One skilled in the art will also recognize that top frame 102 may be supplemented with further information and/or controls or other features, all of which are relevant or useful to client/users who are visiting web pages such as web page 101.

Within a left frame 106, there is a plus button 107 and a minus button 108, both of which are placed next to a menu item 109, which menu item may be composed of parameters, such as the four making up menu item 109, i.e. a menu number 109a, a menu price 109b, an item title 109c and an item description 109d (parameters 109a, 109b, 109c and 109d are collectively referred to hereafter as “parameters” or “ordering information”). Menu item 109, as well as each of the other menu items that follow, may be selected for ordering by simply clicking or invoking, via a mouse or other device, plus button 107. Such an action results in a computer program function (see FIG. 6 at function additem( ) 601) being called which acts upon menu item 109's relevant parameters, which in this instance include menu number 109a, menu price 109b and item title 109c. In this embodiment of the present invention, function additem( ) 601 has been written in Javascript (see FIG. 6 at function additem( ) 601). However, such a computer function could just as easily be written in another computer language, as long as a browser, or other application device in use, is capable of compiling the computer language.

Once function additem( ) 601 is called by plus button 107, menu item 109's relevant parameters are then registered in a right frame 110 for calculation and further manipulation. FIG. 1B illustrates the result of such a computer function (see FIG. 6 at additem( ) 601) being called, with the relevant parameters of menu item 109 then being registered in right frame 110. Thus, right frame 110 starts off as being a clear field when web page 101 is first downloaded by a client/user (see FIG. 1A). Only when plus button 107 is selected by the client/user does the relevant ordering information contained in menu item 109 get passed to right frame 110. This passing of menu item 109's relevant parameters occurs via another computer program function (see function displaymenuorder( ) 603) which is written in Javascript. When menu item 109's parameters are passed to right frame 110, a quantity box 111 registers the quantity of menu items selected. The result of this process is that a client/user may order multiple quantities of menu item 109 merely by using a mouse or other device to click or select plus button 107 a number of times until the desired quantity for menu item 109 is programmatically achieved in quantity box 111. Thus, each time plus button 107 is clicked or selected, this action increases the quantity desired by the client/user by a defined amount, such as the integer one in the present embodiment, which desired amount is then programmed into quantity box 111 via function additem( ) 601. In conjunction with this process, menu item 109's item title 109c and menu price 109b are registered in a parameter field 112 and as menu item 109's quantity increases, a cost parameter 112b is automatically updated, by means of a function displaymenuorder( ) 603, to reflect the new cost of menu item 109. The new cost set forth in cost parameter 112b would thus be menu item 109's menu price 109b multiplied by the quantity set forth in quantity box 111.

In similar fashion, FIG. 1C illustrates that minus button 108 may also be selected, which results in a different computer function (see FIG. 6 at function decrease item( ) 602) being called which causes menu item 109's quantity to be decreased a defined amount, such as the integer one, each time minus button 108 is clicked or invoked. This process enables a client/user to thus control the type and amount of items selected without having to manually type in any information concerning the item which has been selected.

FIGS. 1D-F illustrate how multiple items may be selected in multiple quantities for registry in right frame 110 using plus button 107 and minus button 108 for each particular selectable item on a menu or order form. Each time such an item is selected, its quantity is calculated in quantity box 111 and its relevant parameters are passed to parameter field 112. A total cost for all of the items selected is then automatically generated, in a total cost field 113, each time a new item is added to right frame 110, or each time the quantity of an existing item is increased or decreased in right frame 110. This is done utilizing a function displaymenuorder( ) 603 (see FIG. 6 at function displaymenuorder( ) 603), which automatically generates the running total maintained in total cost field 113. Utilizing this process, multiple items can be chosen in differing quantities and their respective costs, based on their price and quantity selected, can then be automatically calculated, with a running total kept of the total amount of an order. Furthermore, this can all be done using a mouse or other device, which, in the case of a mouse, the client/user simply points and clicks to obtain the desired result. Thus, no manual entry of any information relating to the registry of an order in right frame 110 is required. One skilled in the art will also appreciate that the plus/minus button system for selecting menu items which is demonstrated in the present embodiment represents only a single way to organize plus/minus button selecting of items. In fact, the plus/minus system can be effectuated in a number of ways to carry out the task of enabling client/users to select the items they want in the manner they want. For instance, with respect to restaurant menus, plus/minus buttons could be placed next to each subset of a particular food item in order to allow the client/user to pick the particular item he or she wants in the manner he or she wants. If the food item was, for example, chow mein, the client/user could be given a choice of chicken, beef, or shrimp, with these choices be arrayed lengthwise across the web page while remaining a line below the title for the food item. Plus/minus buttons could then be placed in front of each choice so that a client/user could quickly and easily pick the type and number of servings of chow mein he or she wanted. Such an arrangement might look as follows:

“1. Chow Mein—best chow mein in town.

+w/Chicken—$5.95+−w/Beef—$6.95+−w/Shrimp—$7.95”

With this arrangement set forth on the web page, the client/user could then choose exactly what type of chow mein he or she wanted along with the quantity he or she wanted without having to shift from page to page to carry out the selection. At the same time, the client/user would be able to immediately increase or decrease the quantity or quantities of his or her order simply by clicking the plus/minus buttons set forth in front of each choice.

FIG. 2A illustrates a menu item 203 being selected by a plus button 201, which results in an overlay window 204 being called by means of a computer program function, which for purposes of this embodiment, is named a function showPizzaWin( ) 604 (see FIG. 6 at function showPizzaWin( ) 604). In the present embodiment, overlay window 204 is defined within function showPizzaWin( ) 604 to overlie just a portion of web page 101. Defining overlay window 204 in this fashion allows a client/user to continue viewing web page 101 without the client/user having to move back a forth between web page 101 and overlay window 204, as would be required if overlay window 204 was, in typical fashion, left fully expanded by default. Overlay window 204 can also be grabbed, for instance, by positioning a mouse pointer over overlay window 204's title bar and then holding down the left click mechanism on the mouse and then moving overlay window 204 to wherever the client/user desires within web page 101. Moving overlay window 204 in this fashion allows the client/user to see each part of web page 101 whenever the client/user desires.

Within overlay window 204, there is, in the present embodiment, a checkbox field 205, which is composed of checkboxes, and a component parameter field 206, which is composed of component parameters, such as a component description and component price. The checkbox field 205 and component parameter field 206 are arranged so that each checkbox within checkbox field 205 relates to a component description and component price which are placed directly to the right of the particular checkbox in component parameter field 206. The component descriptions and component prices contained in component parameter field 206 may constitute component parts of or additions to menu item 203 (the terms ‘components parts’ and ‘additions’ are collectively referred to hereafter as “component parts”). The component parts within component parameter field 206 may also be selected in any desired combination, by using a device, such as a mouse, to check off each checkbox within checkbox field 205 which corresponds to the component part or parts the client/user wants added to menu item 203.

FIG. 2B illustrates the action of checking off a checkbox, or combination of checkboxes, in checkbox field 205, which then results in a computer program function being called, which computer function has been named for purposes of the present embodiment as a function addPizzaTopping( ) 605 (see FIG. 6 at function addPizzaTopping( ) 605). When invoked, function addPizzaTopping( ) 605 automatically combines or recombines component parts, or combinations thereof (as they are checked off in checkbox field 205) with menu item 203, via function showPizzaWin( ) 604. Thus, combinations of components parts on the order of 20,000,000 possible choices, and upwards, are easily possible and manageable utilizing overlay window 204. Indeed, utilizing overlay window 204, in conjunction with function showPizzaWin( ) 604 and function addPizzaTopping( ) 605, allows component part combinations to be instantly mapped and then combined and recombined by simply using a device such as a mouse to check off, or uncheck for that matter, the checkboxes in checkbox field 205, which correspond to the component parts in component parameter field 206, which the client/user desires.

Other features of overlay window 204 include a clear checkbox button 207 which allows a client/user to clear all checked off boxes at once, rather than having to individually uncheck each checked off checkbox. The client/user can then start the component part selection process again by proceeding through checkbox field 205 and checking the checkboxes for the component parts the client/user desires. A client/user can also cancel the overlay window by clicking or invoking, via a mouse or other device, a cancel overlay window button 208. If the client/user takes this action, overlay window 204 simply disappears from view, with the result that the one page shopping environment is maintained for the client/user, who does not have to use a browser backpage function in order to view Web page 101 again.

Once a client/user has checked off the desired combination of component parts which he or she wants added to menu item 203, the client/user then uses either a mouse, or other device, to click or invoke an add button 209. This results in a computer program function being called, which has been named a function addPizzaToOrder( ) 606 for the purposes of the present embodiment (see FIG. 6 at function addPizzaToOrder( ) 606). Function addPizzaToOrder( ) 606 then takes menu item 203's parameters, which have been combined with the component parts selected in checkbox field 205 by means of function addPizzaTopping( ) 605, and sends them for registry into right frame 110.

FIG. 2C illustrates the result of function addPizzaToOrder( ) 606 being invoked and the client/user's selection being sent to right frame 110. One skilled in the art will recognize that this process can take place in a variety of configurations, while at the same time using myriad types of component parts. For instance, the component parts set forth in overlay window 204 could just as easily be calories associated with various types of foods, and/or the manner in which the food items are prepared. Such an embodiment would enable one, acting over a communications network such as the Internet, to quickly and easily design a diet which tracked seemingly endless combinations of foods by, for example, their calorie count, or fat count, or protein count. Other embodiments could include menus which allow users to configure parts, including add ons, for mechanical devices, such as computers or automobiles. Or embodiments could include applications which allows client/users to create forms or designs, or answer questionnaires, such as insurance or stock brokerage applications.

FIG. 3a illustrates a number of items which have been registered in right frame 110 and which are ready for final ordering. At this point, a client/user can decide to click or invoke a clear order button 304, which completely clears the register of items set forth in right frame 110. The client/user, if he or she chooses to clear his or her register of items, can then proceed with a new order by using plus and minus buttons contained in left frame 106. Alternatively, and in order to give a client/user maximum flexibility, a client user can manually input new quantity amounts in quantity box 111 and then click or invoke an update button 305. Once update button 305 is invoked, a computer program function is called, which, for the purposes of the present embodiment, is named a function updatemenuorder( ) 607 (see FIG. 6 at function updatemenuorder( ) 607). When called in this manner, function updatemenuorder( ) 607 automatically updates individual item price amounts and the total order amount in the register contained in right frame 110. Thus, a client/user is provided with the flexibility to use either a mouse, or other device, to carry out the selection of menu items. Alternatively, or once an input is chosen, the client/user can choose to alter the quantities relating to the particular menu item by manually typing in the desired menu item quantity into quantity box 111.

Lastly, once a client/user has registered the exact menu items he or she wants in the exact manner he or she wants, a client/user can then proceed with final ordering. To do this, a client/user can either input preselected identifiers in an email box 302 and a password in a password box 303 and then click or invoke an order button 306, or the client/user can choose to bypass the preselection identifier process and proceed directly with clicking or invoking order button 306.

The result of invoking order button 306 is that a computer program function is called, which, for purposes of this embodiment, is named function openPreOrderWin( ) 608 (see FIG. 6 at openPreOrderWin( ) 608). The purpose of function openPreOrderWin( ) 608 is to ensure that no letters or negative numbers or other non-numeric symbols are inadvertently inputted into quantity box 111. If such an action has taken place, then function openPreOrderWin( ) 608 alerts the client/user to the inadvertent use of the non-numeric parameter and instructs the client/user to change the incorrect quantity parameter to a numeric symbol. If such an action has not taken place in the first instance, or, if the errors have been corrected, then function openPreOrderWin( ) 608 calls another computer program function, which is entitled a function openPreOrderWin1( ) 609 (see FIG. 6 at function openPreOrderWin1( ) 609). The purpose of function openPreOrderWin1( ) 609 is to carry out a posting method whereby the final ordering information, which is registered in right frame 110, is transmitted to an HTML defined ordering form. This HTML form is, in turn, generated by a CGI program maintained on the server which originally sent web page 101 to the client/user's computer. Such a CGI program will be familiar to one skilled in the art and thus will not be described in detail herein.

FIG. 3B illustrates an order overlay window 307, which contains an HTML order form 308 that has been generated by the aforementioned CGI program. Order overlay window 307's parameters are defined via function openPreOrderWin1( ) 609 so that order overlay window 307 is sized to overlie only part of web page 101. This feature allows a client/user to proceed with the process of completing his or her order, while at the same time providing the client/user with the ability to immediately start the ordering process over again directly within web page 101 by closing out order overlay window via a order cancel button 310 (see FIG. 3 C).

Once function openPreOrderWin1( ) 609 is invoked, the CGI program is called. The CGI program then receives the order information registered in right frame 301 and inputs this ordering information into the proper fields in HTML order form 308. HTML order form 308 is then called by function openPreOrderWin1( ) into order overlay window 307 and sized via function openPreOrderWin1( ) so that it fits within order overlay window 307. At this point, HTML order form 308 contains all of the client/user's order information which was selected and registered in right frame 301. Additionally, if the client/user has entered his or her preselection identifiers into email box 302 and password box 303, then HTML order form 308 also contains the client/user's prior ordering information, such as the client/user's name, address, phone number, credit card number and credit card expiration date. On the other hand, if a client/user has not inputted preselection identifiers into email box 302 and password box 303, then HTML order form 308 contains the client/user's order information sans the client/user's identification information. This information, however, may be simply filled in by the client/user into the relevant sections of HTML order form 308.

Once HTML order form 308 is completed, the client/user can then complete the ordering process by clicking or invoking order submission button 309 (see FIG. 3C). The ordering information, including the client/user's identification information, may then either be submitted directly to the host of the web page for completion of a transaction, or may be transmitted to a third party via, for instance, email so that the transaction is completed by the third party.

Of course, at any time, the client/user can stop the ordering process and eliminate order overlay window 307 be clicking or invoking order cancel button 310, which will result in order overlay window 307 being closed and the client/user being able to proceed anew with ordering within web page 101 or being able to close web page 101 entirely. Thus, throughout this one page ordering process, the client/user maintains the flexibility to leave the ordering process at any time without sacrificing the client/user's ability to immediately start the ordering process over again if he or she so desires.

FIG. 4 is a flow chart of a routine for enabling and then processing one page shopping orders by a client/user. This routine illustrates one embodiment of the present invention whereby items may be selected directly for ordering via a plus/minus button selection system. With respect to items which have multiple component parts, the routine illustrates that a client/user may add or subtract such component parts to or from his or her selected item, via an overlay window, so as to provide the client/user with an item which is uniquely suited to the client/user's individual needs. Once items are selected, either directly via the plus/minus button system or through the overlay window after the composition of the items have been altered to meet the client/user's needs, then the items are registered in a frame. Within the frame, the selected items are then totaled so that at all times, the client/user can see exactly what he or she has ordered and how much such an order is going to cost based on each change the client/user makes to the order. Once a client/user has selected all the items he or she desires, which are composed in the exact manner the client/user wants, the routine illustrates the manner in which the client/user's registered items may be formatted for final ordering. At this stage, which takes place within another overlay window, so that the client/user is still within the web page he originally entered into, the client/user can input instructions such as payment instructions and delivery instructions which will allow the order to be completed. The client/user can then either submit the order or cancel it and then either proceed with another order or leave the web page altogether.

The illustrated routine begins with step 401, where a client/user selects an item for ordering. If the selected item has component parts which are themselves subject to selection, then the client/user proceeds to step 402. In step 402, the client/user views the components parts which may be added to his or her selection via an overlay window. In step 403, the client/user selects the component parts which he or she wants added to his or her selected item, in the combination he or she so desires. In step 404, the client/user can clear the selected component parts or else proceed to step 405 and cancel the overlay window. If the client/user chooses to proceed with the selection, step 406 then adds the selection to the client/user's registration of items. This adding of the selection occurs via step 410.

If the selected item does not have component parts, then the client/user may choose either step 408 or step 409 depending on whether the client/user wants the quantity of the item either increased or decreased in the registration of selected items. As with the registration of items which have component parts, this step of registering an increase or decrease in the quantity of an item occurs in step 410. The actual increase or decrease in the quantity of the selected item then takes place in a quantity field which, depending on whether an item's quantity is increased or decreased, is either step 412 or step 411. At this point, step 413 takes place which involves calculating the cost for each individual item selected by the client/user. Next comes step 414 which calculates the total amount for all items ordered, including any taxes which may be owed on the selections.

Next comes three alternative steps. If step 413 is invoked, this step clears the client/user's selections and allows the client/user to start his or her order all over again from scratch at step 401. Alternatively, if the client/user wants to make changes to the quantity of the items he or she has ordered, without using the plus/minus buttons represented by steps 408 and 409, then the client/user may directly input into the quantity fields represented by steps 411 and 412 the exact quantity of a particular item which the client/user desires. Once this is done, step 419 is then invoked which serves to update the new quantities for selected items, along with the new prices associated with those new quantities, in the text fields represented by steps 411 and 412, as well as in the calculation steps 413 and 414. The third alternative occurs if the registry of items contains the selected items in the exact form and quantity desired. If this is the case, then step 416 is invoked. Step 416 serves to submit the client/user's selections for final ordering. When the client/user's selections are submitted, step 417 checks the selections first to make sure that they do not contain inadvertent entries of letters, or non-numeric symbols or negative numbers. If such invalid parameters are present, then step 418 directs the client/user as to what errors have been made, as well as to how to correct them, in order to validate the client/user's selections. Step 419 is then invoked which corrects the errors contained in the client/user's selections.

If, however, the client/user's selections do not contain any inadvertent entries or errors, then step 420 is invoked. Step 420 is an intermediary step which invokes step 421. Step 421, in turn, opens an order overlay window through which an HTML defined form is called by means of a CGI program. Steps 421 sizes the HTML defined form, which, as a result of the CGI program, now contains the client/user's selections and their respective costs and their total cost including taxes. The sizing by step 421 results in the HTML defined form fitting within the overlay window, which in turn overlies the web page where this entire process has taken place. The client/user may then input his or her delivery and payment instructions into the HTML form so that his or her order is ready for submission.

Next, step 422 submits the client/user's order so that the order may be filled. Alternatively, the client/user may proceed to step 423 which allows the client/user to cancel his or her order. If this occurs, then the order overlay window disappears and the client/user is back to the starting point of step 401. All of this thus occurs so that at any point in the ordering process, the client/user may stop the ordering process and begin anew without having to shift to different pages or without having to manually retype in selection information.

FIG. 5 is a block diagram illustrating an embodiment of the present invention. This embodiment illustrates one page shopping in a networked environment such as the Internet, where files may be downloaded and the programs contained on them compiled via a compiler contained on a browser, or some other similar device, which allows for client/users to interact with servers and the programs contained in their files via a graphical, text interface. The block diagram breaks the embodiment of the present invention down into two separate parts. First, there is a server system 501, which is made up of a server engine 502, an order database 503, a customer database 504, and web page files 505 which the client/user is requesting being downloaded. Server engine 502 receives client/user requests over a communication network utilizing a language protocol such as HTTP and then responds to the requests by downloading to the client/user the particular web page files requested, which in this case are web page files 505. The client/user then completes the selection process. If the client/user has previously provided server system 501 with preselected identifiers so that these identifiers were maintained in customer database 504, the client/user's prior order information is then automatically inputted for the client/user when he or she proceeds with the final ordering of his or her selections. Once the ordering process is complete and the client/user submits his or her order to the server system, all of the information contained in the order is entered into order database 503 which initiates the process of completing the client/user's order. Since this process of entering information into a database is readily recognizable to one skilled in the art, it will not be discussed further herein.

The second part to the block diagram is a client system 506. This system is composed of a browser 507, or similar such device, which is capable of compiling the web page files 505 which are requested by the client/user from server engine 502. Once the web page files 505 are requested from server engine 502, they are then downloaded into the client/user's RAM, or similar such storage mechanism. Once downloaded into the client/user's RAM, web page files 505 become a web page program 508 which the client/user is able to operate independently through his or her browser 507, without having to receive further inputs from the server engine. The client/user proceeds with ordering his or her selections in the one page shopping environment created by web page program 508 and, when completed, then transmits his or her order back to the server system 502 for fulfillment of the client/user's order.

FIG. 6 contains a listing of an embodiment of the present invention written in Javascript. In order to implement the computer program set forth in the listing, the program merely needs to be saved as a HyperText Markup (“HTM”) file or an HTML file and then downloaded to a browser, such as Netscape Navigator or Internet Explorer, which is capable of compiling Javascript, or some other computer language that the computer program has been written in. The listing contains a function additem( ) 601 which allows selected menu items to be added to, and their quantities increased, in the register in right frame 110. Also contained is a function decrease( ) item 602, which performs the opposite function of decreasing the quantities of the selected menu items contained in right frame 110. Also contained is a function showPizzaWin( ) 604 which, when working in conjunction with a function addPizzaTopping( ) 605 and a function addPizzaToOrder( ), allows client/users, via an overlay window, to combine component parts, which are associated with particular menu items, in a myriad of combinations so as to greatly expand the choices available to the client/user when selecting particular items.

A function displaymenuorder( ) 603 receives the selections which are transmitted to the right frame 110 via functions additem( ) 601, decreaseitem( ) 602 and addPizzaToOrder( ) 605, and then calculates their individual and cumulative cost totals for the client/user. Utilizing function displaymenuorder( ) 603 to invoke a clearing mechanism and an updating mechanism, which mechanisms are reflected, respectively in a function clearorder( ) 610 and a function updatemenuorder( ) 607, the client/user may then either clear the register in right frame 110 or update quantity amounts for selected items, along with their related parameters, in quantity box 111, parameter field 112, and total cost field 113.

Utilizing a function openPreOrderWin( ) 608, the client/user is then alerted if any incorrect values have been included in his or her registry of items. If so, the client user is alerted by function openPreOrderWin( ) 608 as to what changes need to be made to the selection values. Then if the values are correct, a function openPreOrderWin1( ) 609 opens an overlay window through which is called an HTML defined ordering form. The client/user's item selections are then inputted into this form by means of a CGI program which is called by function openPreOrderWin1( ). The result is that the client/user's order information is passed to a server based form which nevertheless appears as an overlay window in the client/user's browser. The client/user can their either enter his or her delivery and payment instructions into the form and then submit the form for order fulfillment or the client/user can cancel the overlay window, thereby stopping the order without removing the client/user from within the confines of web page 101.

Thus, the present invention presents a static interface environment which saves the client/user from having to shift from web page to web page in order to complete an order, while at the same time providing the client/user with substantially more item selection flexibility than can be found in the myriad of web pages which are currently used by Internet based shopping carts. In fact, utilizing the present invention a client/user can be presented with literally a huge number of possible combinations in a simple and easily digested format all of which occurs within the confines of a static user interface environment. Thus, for instance, the menu of a pizza restaurant can be presented on a single web page and when complex choices are called for with respect to particular restaurant items, such as a pizza which comes with a potential of 25 different toppings as well as different crusts, the client/user can utilize the preferred embodiment of the present invention to order any combination thereof (which amounts to over 20,000,000 possible choices) all within the confines of the static user interface environment and without having to proceed through multiple pages to order yet more items. Thus, the present invention not only saves time for client/users, but it also simplifies the manner in which complex choices can be presented.

One skilled in the art will recognize that this presents just one embodiment of the present invention, and that other embodiments can be generated which are particularly suited to the business one page shopping is developed for. Thus, this present invention might be configured to sell computers and any add-ons associated with them. Or the present invention might be configured to allow a client/user to do grocery shopping. Or the present invention might be configured to allow the client/user to order from a wide variety of automobiles and to then select from particular automobiles which extras the client/user wants included with a particular automobile. Or the present invention might be configured to enable a client/user to design a diet plan, or even a workout plan, which calculates how may calories are consumed or used depending on the type of food or exercise regimen involved. Additionally, the manner in which items of information are presented may be changed, with items being presented in a myriad of different formats, such as the register containing selected information being moved to the right or to the top of the page the client/user is looking at. Similarly, other portions of the page may be shifted to suit the preferences of client/users. Likewise, the windows from which item subsets are selected may be arranged in innumerable different ways, so that such windows may be larger or smaller or wider or narrower. Or such windows may be configured in different ways depending on the type of information being presented so that for instance if one were to order a dinner which had, for example, subsets of information such as choices of salad dressings, choices of appetizers, choices of toppings on the appetizer selected and choices of the manner in which the dinner entree should be cooked (e.g. cooking a steak either rare, medium rare, medium or well done), all of these subsets of information could be presented in a single overlay window. The result would then be that an entire meal, which has potentially thousands of different ordering combinations, could be selected via a single ordering page, without the client/user having to go from page to page to complete the selection process. Of course, such an application of the present invention would not be restricted to just ordering food. In fact, the present invention could be configured to apply to any selection process which involved multiple levels of choices so that all of the choices could be made within a static environment with the result of the selection process being rendered within the confines of the same static environment.

The aforedescribed embodiments of the present invention should not be construed to limit the scope of the invention, particularly since many changes and modifications may be made to the present invention without departing from its essential characteristics. As a result, because it is not intended to limit the present invention to the forms and applications specifically enumerated and described herein, all suitable modifications and equivalents may be regarded as falling within the scope of the invention as set forth in the appended claims and their equivalents.

What is claimed is:

1. A method for enabling the display, selection, configuration, manipulation and processing of information via electronic network in a static interface environment comprising:
means for generating, for a client/user, a screen interface which displays lists of information within its confines;
means for enabling a client/user to select desired information in the static interface environment, which the client/user is presented via an electronically networked device, and which the client/user is enabled to configure and manipulate within this environment;
means for enabling the processing of information which a client/user has selected, manipulated and configured within the confines of the presented static interface environment;
whereby a producer or disseminator of information, items, products or services can display any such items via a single static interface environment; and
whereby client/users can then select, configure, manipulate and order any such information, items, products, or services, in any range, quantity or type without leaving the confines of the enabled static interface environment.

2. The method according to claim 1, further including the step of configuring subsets of listed information in a multitude of manners within the confines of the static interface environment.

3. The method according to claim 1, further including the step of utilizing plus and minus representations to enable information to be selected and deselected in defined amounts.

4. The method according to claim 3, further including the step of enabling information to be automatically and/or manually selected for inclusion in a request or order made by a client/user.

5. The method according to claim 4, further including the step of enabling sums associated with information which has been selected to be automatically checked and summed.

6. The method according to claim 4, further including the step of enabling information selected manually to be updated.

7. The method according to claim 5, further including the step of enabling information selected by the client/user to be cleared so that the client/user can commence a new order.

8. The method according to claim 5, further including the step of enabling a password associated with a particular client/user to be entered to identify the client/user so as to enable pre-selected information to be automatically returned for the purpose of enabling such information to be ordered again.

9. The method according to claim 5, further including the step of enabling the client/user's order to be checked for possible errors.

10. The method according to claim 1, further including the step of enabling the presentation of information in different sized formats.

11. The method according to claim 10, further including the step of enabling the display of information in differing manners of presentation.

12. The method according to claim 11, further including the step of enabling the presentation of information via different interface applications.

13. A method for enabling the display, selection, configuration, manipulation and processing of subsets of alternative information which apply to higher level information via computer network in a static interface environment comprising:
means for generating a multitude of listed subset information for a client/user in conjunction with the generation of the higher level information to which the subsets relate;
means for enabling a client/user to view, select, configure and manipulate a multitude of possible subset choices within the confines of the same static interface wherein the higher level information, to which the subset information, relates;
means for enabling the processing of multiple choices of information which has been selected, configured and manipulated within the confines of the static interface environment;
whereby combinations of choices can be generated, selected and manipulated which are orders of magnitude greater than those available via a numbered list of information which is presented in a standard interface environment; and
whereby such choices of information are presented, notwithstanding their increased complexity, within the confines of the static interface environment

14. The method according to claim 13, further including the step of utilizing subsets of subsets of information to display secondary, tertiary and even quartic levels of choices associated with higher level information.

15. The method according to claim 13, further including the step of enabling the adding and/or subtracting of subsets of information from higher level information.

16. The method according to claim 15, further including the step of enabling the clearing of subsets of information.

17. The method according to claim 13, further including the step of enabling the presentation of subsets of information in different sized formats.

18. The method according to claim 17, further including the step of enabling the display of subsets of information in differing manners of presentation.

19. The method according to claim 18, further including the step of enabling the presentation of subsets of information via different interface applications.

20. The method according to claim 15, further including the step of enabling the ordering of higher level information which has been modified by the reference of its subsets to itself

21. The method according to claim 13, further including the step of enabling multiple items of information to make reference to the same subset or subsets of information so as to reduce data levels that need to be transmitted in order for the selection and/or order process to be effectuated.
